(19) United States
(12) Patent Application Publication
(10) Pub. No.: US 2015/0100507 A1
(43) Pub. Date: Apr. 9, 2015

(54) DOMAIN PROTECTED MARKS LIST SERVICE

(71) Applicants: BENOIT LEVAC, Ottawa (CA); Wayne Michael MacLaurin, Kirkland, WA (US); Chris Cowherd, Kirkland, WA (US)

(72) Inventors: BENOIT LEVAC, Ottawa (CA); Wayne Michael MacLaurin, Kirkland, WA (US); Chris Cowherd, Kirkland, WA (US)

(21) Appl. No.: 14/314,801

(22) Filed: Jun. 25, 2014

Related U.S. Application Data
(60) Provisional application No. 61/844,283, filed on Jul. 9, 2013.

(51) Int. Cl. G06Q 10/10; G06Q 50/18

(52) U.S. Cl. CPC G06Q 10/10; G06Q 50/184
USPC 705/310

(57) ABSTRACT

A domain protected marks list (DPML) blocks domain name registrations that contain validly registered trademarks. When a request is received from a requestor for a DPML registration for a string comprising a trademark, it is verified to ensure the validity of the trademark and to further ensure that a prior block on the string does not already exist in one or more registries. Upon the verification, a DPML block is registered across the registries which do not comprise a domain name that corresponds to the string. This prevents domain name registrations for the string within the registries by parties other than the requestor.

### RELATED APPLICATIONS

The present application claims the benefit of the filing date of Prov. U.S. Pat. App. Ser. No. 61/844,283, filed Jul. 9, 2013 and entitled “Domain Protected Marks List Service,” the entire disclosure of which application is hereby incorporated herein by reference.

### FIELD OF THE TECHNOLOGY

At least some embodiments of the present disclosure relate to domain name registration and trademark protection.

### BACKGROUND

The Internet uses a domain name system (“DNS”) that maps domain names items such as other domain names, objects, name servers, and Internet Protocol addresses. Internet Protocol addresses shall hereinafter be referred to as “IP addresses,” which reference should also be understood in this disclosure to include equivalent private computer addresses. Domain names are a convenient alternative to IP addresses, as most humans have difficulty remembering and faithfully reproducing IP addresses like 209.19.43.100. A user who wants to view a web page associated with a domain name may enter the domain name (e.g., “acme.com”) in the address line of a browser. The domain name system maps the domain name to an IP address of the server hosting the web page, allowing the browser to access the web page on the server.

Domain registries operate top-level domain names or domain names to the “right of the dot” referred to herein as “TLDs.” For example, Verisign, Inc. presently operates the .com and .net registries. Registries may, though typically do not, interact directly with registrants who wish to register domain names. Typically, registrants register domain names through intermediaries, called registrars. Registrars may be accredited by the Internet Corporation for Assigned Names and Numbers, or “ICANN.” ICANN currently has the contractual authority to add new TLDs to the root domain name servers and enters into contracts with the registry operators which provide domain name registration services in the TLDs. The registry maintains a database of the domain names that are currently registered within its TLD. When a prospective registrant submits a request to a registrar to register a domain name, the registrar submits the request to the relevant registry. Typically, the registry validates the request, timestamps the request, checks the request against the database of then-currently registered domain names, and may perform other operations. If the domain name is not then-currently registered, the registry allows the domain name to be registered by the first registrar to submit the request. Alternatively to the first-come first-served domain name registration model, other methods are sometimes employed, such as auction of domain names, “sunrise periods” (during which trademark claimants are offered preferential registration rights), and rights-of-first refusal (such as Verisign's proposed but not yet implemented “Wait List Service”). The registry returns the result(s) to the registrar(s) who requested the domain name registration. If the domain name has previously been registered (if it is already listed in the database of then-currently registered domain names), the registry returns a code which indicates that the requested domain name registration is not available.

### SUMMARY OF THE DESCRIPTION

At least some embodiments of systems and methods to protect the rights of a trademark owner in domain registration are summarized in this section.

In one embodiment, a domain name system is configured to allow the registration of a user-identified string to prevent the registration of the string as a domain name under one or more top level domains, such as .com, .net, .org, etc. The domain name system is configured to register a user-identified string as a pseudo domain name under a pseudo top level domain, such as .dpml, using a communication protocol for registering a domain name under a top level domain. The registration of the string as a pseudo domain name under the pseudo top level domain allows the domain name system to reject the registration of the string as domain names under one or more top level domains, unless the registration is from a user in possession of a digital document that demonstrates the ownership of a relevant trademark. To protect the rights of the trademark owner, the domain name system is configured to reject the registration of a string as a pseudo domain name under the pseudo top level domain, unless the request is from a user in possession of a document that demonstrates the ownership of a relevant trademark. Using the system, an owner of a trademark can register a string, same or similar to the trademark and with a proof of the trademark ownership, in a way similar to registering the string under a top level domain, to prevent the string to be registered by unauthorized parties, who do not have the proof of the trademark ownership, from registering the string as domain names under one or more top level domains.

In one aspect, a method for registering a domain name block implemented by a computer is disclosed in an embodiment. The method includes, receiving, at the computing apparatus, a request for registration of a domain name block across a plurality of TLDs, wherein the domain name block includes a string which in turn includes a registered trademark. A digital proof of ownership of the trademark associated with the request which is signed by a trusted authority is also received by the computing apparatus along with the request. In an embodiment, the digital proof of ownership is a SMD (Signed Mark Data) file and the validity is verified by the Trademark Clearing House (TMCH). The computing apparatus further determines, if the block has already been registered by another party and proceeds with registering the string as a domain name block based on the determination. In an embodiment, the string is not registered as a domain name block if it is determined that the block has already been registered by another party.

In an embodiment, the string includes a variation of the registered trademark such that the registered trademark is included in string at a beginning, center or end of the string.

In an embodiment, the method of registering the domain name block further includes verifying, by the computing apparatus, validity of the digital proof of ownership by determining if the string includes any label identified in the SMD (Signed Mark Data) file; and if not, the request for registration is rejected.

In an embodiment, the method of registering the domain name block further includes checking for the string in a distributed database associated with DPML blocking service. If the string is found to exist in the distributed database, then a message that the string is unavailable is transmitted by the computing apparatus.

In an embodiment, the string to be registered as a domain name block includes a DPML suffix appended to the string.

A computing apparatus having at least one processor and a memory storing instructions configured to instruct the at least one processor is disclosed in another embodiment. The instructions cause the processor to receive a request for registration of a domain name block across a plurality of TLDs, wherein the domain name block includes a string including a registered trademark. The processor also receives a digital proof of ownership of the trademark associated with the request, signed by a trusted authority. The instructions further cause the processor to determine if the block has already been registered by another party and to register the string as a domain name block based on the determination. In an embodiment, the memory stores further instructions that cause the processor to determine if the string includes any label identified in the proof of ownership, such as, the SMD (Signed Mark Data) and to reject the request for registration if the string does not include any label identified in the SMD file.

In an embodiment, the memory stores further instructions that cause the processor to check for the string in a distributed database associated with the DPML blocking service. A message is transmitted to the requestor that the string is unavailable if the string is found to exist in the distributed database. In an embodiment, the string to be registered for the domain name block includes a DPML suffix appended to the string.

A computer-storage medium storing instructions configured to instruct a computing apparatus is disclosed in an embodiment. The instructions cause the computing apparatus to receive a request for registration of a domain name block across a plurality of TLDs, wherein the domain name block includes a string including a registered trademark and to receive a digital proof of ownership, signed by a trusted authority, of the trademark associated with the request. In an embodiment, the string may be a variation of the registered trademark. In an embodiment, the instructions further enable the computing apparatus to verify validity of the digital proof of ownership. Based on the instructions, the computing apparatus further determines if the block has already been registered by another party. The string is registered as a domain name block based on the determination.

A computer-implemented method for registering a string as a domain name is disclosed in one embodiment. The method includes receiving, by a computing apparatus from a prospective domain name registrant, a request for registering a string as a domain name in a top level domain. The computing apparatus determines if the string is a registered domain name in the top level domain or if a DPML (Domain protected marks list) registration exists for the string. If it is determined that by the computing apparatus that the string is a currently registered domain name in the top level domain or if the DPML registration exists for the string, then, registration of the string as a domain name in the top level domain is blocked. The computing apparatus overrides the registration block of the string based on the DPML registration and registers the string as a domain name in the top level domain if the prospective domain name registrant also provides digital proof of ownership, signed by a trusted authority, of the trademark associated with the request. When the digital proof of ownership is not received from the prospective domain name registrant, the request for registration is rejected by the computing apparatus.

In an embodiment, the method further includes, determining, by the computing apparatus, if the digital proof of ownership includes the string if the string is not registered as a domain name in the top level domain. If the digital proof of ownership includes the string, then the string is registered as a top-level domain by the computing apparatus. The request for registration is rejected by the computing apparatus if the digital proof of ownership does not include the string.

### BRIEF DESCRIPTION OF THE DRAWINGS

The embodiments are illustrated by way of example and not limitation in the figures of the accompanying drawings in which like references indicate similar elements.

FIG. 1 illustrates a flow chart that details the process of generating a DPML registration according to one embodiment.

FIG. 2 illustrates a flowchart that details a method of registering a domain by a registry according to one embodiment.

FIG. 3 shows a system for protecting trademarks via the DPML registrations according to one embodiment.

FIG. 4 illustrates a computing apparatus according to one embodiment.

FIG. 5 illustrates a data processing device according to one embodiment.

### DETAILED DESCRIPTION

Disclosed is a method of registering domain names and an apparatus thereof. In the disclosure, a transaction session between a registry and a registrar and/or registrant over the Internet or another computer network may use communication protocols, such as the Extensible Provisioning Protocol (“EPP”) and the Registry Registrar Protocol (“RRP”) and other application programming interfaces (or “API's”) specific to registry operations, in combination with other communication or transport protocols. Performing the function of conducting a transaction session among a registry, registrar, and a registrant typically includes the communication by a registry with its own databases, storing and accessing the result of the resulting transaction session(s) in a digital database which occur between a registry and a registrar and/or a registrant.

Domain Protected Marks List (DPML) provides a rights protection mechanism (RPM) that blocks domain name registrations that contain validly registered trademarks. It provides trademark holders with a tool to protect their intellectual property by enabling them to block, across multiple top level domain registries, the registrations of domain names that contain their registered trademarks. In an embodiment, the DPML service prevents the registration of domain names containing registered trademarks in TLDs (Top level Domains) of registries participating in the DPML service. The rights of trademarks holders are protected by preventing the registration of domain names listed in the DPML in participating TLDs. In an embodiment, a DPML registration is a string of letters or numbers (a “string”) that a trademark holder wishes to protect. However, DPML is not, itself, a top-level domain or a domain registration. The string can be an exact match of the trademark in one embodiment or can contain a trademark at the beginning, end or anywhere in the middle as long of the string as the contained trademark is contiguous. The string thus used for a DPML registration does not need to be a trademark but can contain the trademark. For example MICROSOFT owns the trademark ‘XBOX’. However, if MICROSOFT does not own a trademark for ‘xboxx’, MICROSOFT can purchase a DPML registration for ‘xboxx’ because it fully contains their trademarked term ‘XBOX’. Creating a DPML registration for ‘xboxx’ can prevent ‘xboxx’ from being registered as a domain name in the TLDs at registries participating in or offering the DPML service.

If a trademark holder wishes to protect variations of the trademark, a DPML registration can be purchased through participating registrars. In an embodiment, a single DPML registration can be purchased for each variation of the trademark. However, one DPML registration can be used to block domain registrations of the variation in multiple TLDs at a time. In one embodiment, registrars can pass a fully qualified domain name (FQDN) in an EPP command to create the registration. In order for the blocked string to appear properly in DNS, it is formatted as a fully qualified domain name. In on embodiment, registrars append a (DPML) suffix to each string as part of the DPML registration. By the way of illustration, the DPML suffix appended by the registrars can be ‘.dpml.’ For example, if the blocked string is Thyverizon′, registrars can pass ‘myverizon.dpml’ as the FQDN in the EPP command and this is the domain name that is published to the DNS.

After a trademark holder register their valid, registered, word mark in the Trademark Clearing House (TMCH), the trademark holder can purchase a DPML registration. The TMCH issues the holder of the trademark a file called the Signed Mark Data (SMD). In an embodiment, the SMD is a digital file that contains the data related to the registered mark. In one embodiment, SMD file can be well-formatted XML (extensible Markup) data that includes a digital signature encoded to be compatible with XML. The SMD file is a part of a mechanism that authorizes a set of labels for domain registration and that the TMCH has verified the trademark meets certain requirements. The SMD file contains the domain labels that are authorized for use as domain registrations. In an embodiment, a trademark holder supplies the SMD file to the registrar at the time of purchasing the DPML registration so that the registrar can confirm the authenticity of ownership and obtain a list of permissible labels for domain registrations. In an embodiment, the TMCH will only distribute the SMD files to trademark holders eligible for sunrise registrations so that only trademark holders with ‘in-use’ trademarks may purchase a DPML registration.

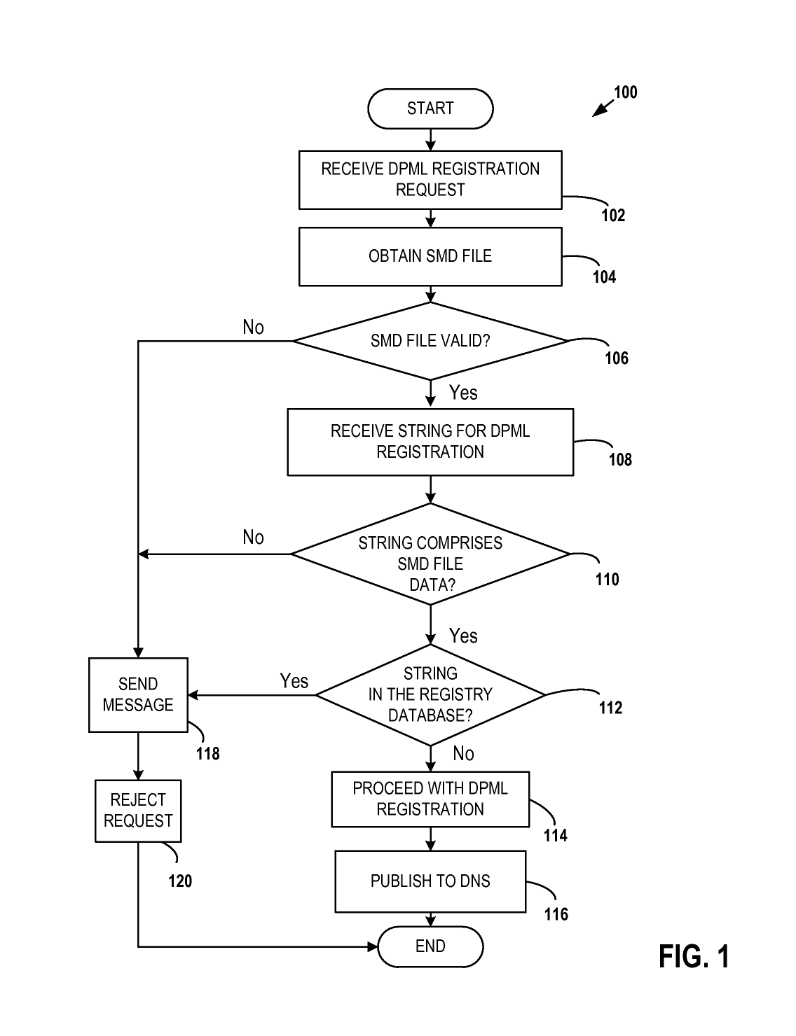

FIG. 1 is a flowchart 100 the details the process of generating a DPML registration at a participating registrar in accordance with one embodiment. The process can be executed by a computing device including one or more processors that execute programming logic stored on processor-readable storage media for implementing the procedure described herein. The method begins at 102 with a processor associated with a registrar receiving a request for DPML registration for a string that includes a registered trademark. During the registration process a prospective registrant who is an owner of the trademark can be instructed to provide the SMD file which was received by the trademark holder from the TMCH for the ICANN mandated sunrise period. At 104, the SMD file associated with the DPML request is obtained by the processor. The processor determines if the received SMD is valid at 106 thereby authorizing the trademark holder and listing permissible DPML labels. In an embodiment, the validity of the SMD file can be determined via verification with TMCH that issued the file. If it is determined at 106 that the SMD file is not valid, the request for DPML is rejected 120 and the process terminates. If it is determined at 106 that the SMD file is valid, the registrar proceeds to 108 wherein a string or text data to be used for the DPML registration in accordance with embodiments described herein is received. The string that the trademark holder desires to block can be included in the standard domain name filed used for domain registration with the registrar. In one embodiment, the DPML registration string must meet the general requirements for labels for domain names. In one embodiment, the data from the SMD file can be recorded and successful/unsuccessful DPML registrations can be logged against this data. At 110 it is determined if the received string includes the data included in the SMD file. In an embodiment, the DPML registration can be an exact match of the trademark term. In one embodiment, the DPML registration can include an exact match of the trademarked string or term. The trademark term can appear in its entirety at the beginning, the end or in the middle of the DPML registration string.

In an embodiment, the determination at 110 can include verifying that the received string complies with various rules as detailed further infra. In one embodiment, the trademark holder who is a bearer of the SMD file can register an exact match domain regardless of whether they are the registrant of a DPML. The presence of a valid SMD file can cause the SRS (Shared Registry System) to not check the DPML when registering a domain name. The domain being registered must be listed as a valid label in the SMD file. Alternately, during general availability or sunrise, a trademark holder can pass their SMD file at any time to override the DPML check as long as the domain they are registering is listed in the SMD file. In an embodiment DPML services can support IDN (Internationalized domain names) block strings. In one embodiment, the SMD file can contain the encoded a-label of the domain name. However, variants of the domain name may not be included in the SMD as the variant characters are dependent on each registry's own variant mappings. In an embodiment, DPML can support only exact match on any a-label contained in the SMD file. In one embodiment, the SMD file can contain many valid iterations of a domain name. For example, a single SMD for BARNES & NOBLE can contain the following valid strings: barnesandnoble, barnes-and-noble, barnes-noble. When a trademark holder registers a DPML, they can only select one of the valid strings listed in the SMD file. In one embodiment, Barnes & Noble would need to purchase three DPML registrations to cover all of the above strings and if such registrations were purchased, all three strings would be considered exact match registrations. It may be noted that a given TLD cannot be considered part of the trademark. For instance, if there is a TLD of ‘.mail’, the string ‘hot.mail’ cannot be blocked for the trademarked term ‘hotmail’. In one embodiment, a DPML registration that includes the trademark as a part of the registration string can be of any length but a DPML registration that contains only the trademark term is constrained so that it cannot include less than four characters. Alternately, the DPML service prevents DPML registrations that are three characters or less unless it is an exact match trademark.

If it is determined at 110 that the DPML registration string does not include the trademark terms included in the SMD file, a message is sent 118 to the registrant/trademark owner that the domain name containing the string is unavailable for registration with the registries in the subset and the request is rejected 120. If it is determined at 110 that the DPML registration string includes the trademark term, at 112 the string is checked against each of the distributed databases of all the registries participating in the DPML blocking service. If a match occurs in a subset of the registries, a message is sent 118 to the registrant/trademark owner that the domain name containing the string is unavailable for registration with the registries in the subset and the request is rejected as shown at 120. For the remaining registries wherein it is determined at 112 that the string is not in the registry databases, the method will proceed towards DPML registration as shown at 114 and will be published to the DNS at 116.

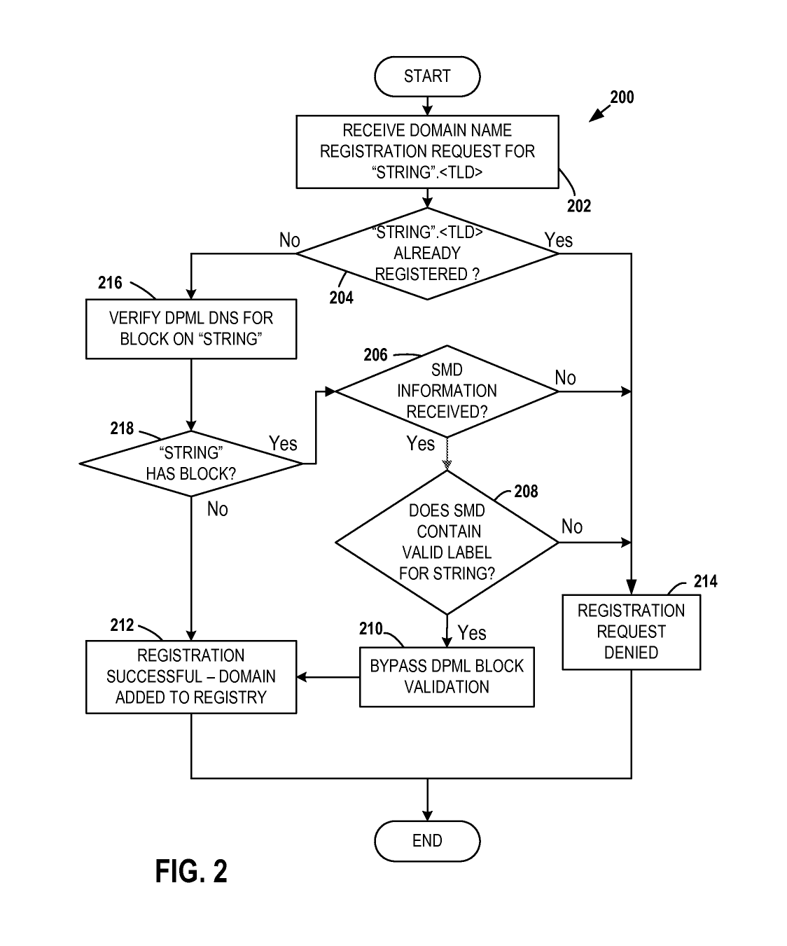

FIG. 2 is a flowchart 200 that details a method of registering “string”.<TLD> domain by a registry in accordance with one embodiment. Upon the registrar issuing a DPML block to a trademark holder, the trademark holder can proceed with registering the string as a domain with the various registries at which a DPML block exists for the string. The method begins at 202 with a registry receiving a domain name registration request for “string”.<TLD>. At 204, it is verified if a domain “string”.<TLD> is already registered. If “string”.<TLD> is already registered, the registration request is denied 214 and the process terminates on the end block.

If it is determined at 204 that “string”.<TLD> is not already registered, the DPML DNS is further verified 216 for a block for “string”. If it is determined at 218 that a DPML block exists for “string”, it is further verified at 206 if SMD information is received. In an embodiment, a trademark holder with a valid SMD file issued by the TMCH can pass the SMD information with the request for registration.

If it is determined at 206 that the SMD information is received, for example, with the request, the received file is verified at 208 to determine if it contains a valid label for “string”. If at 208 it is determined that the SMD file does not contain a valid label for “string”, the registration request is denied 214 and the process terminates on the end block. If it is determined at 208 that the SMD file contains a valid label for “string”, the DPML validation logic is bypassed 210 and “string”.<TLD> domain is successfully added to the registry 212. In an embodiment, the bypassed policies can include string length, string content, trademark composition or SMD label comparison. The registry system can accept any string as a DPML registration if the string does not violate normal validation policies for domain labels.

If it is determined at 206 that SMD information is not received, the registration request is denied 214 and the procedure terminates on the end block.

If it is determined at 218 that a DPML block does not exist for “string”, then a domain for “string”.<TLD> is successfully registered and added to the registry at 212.

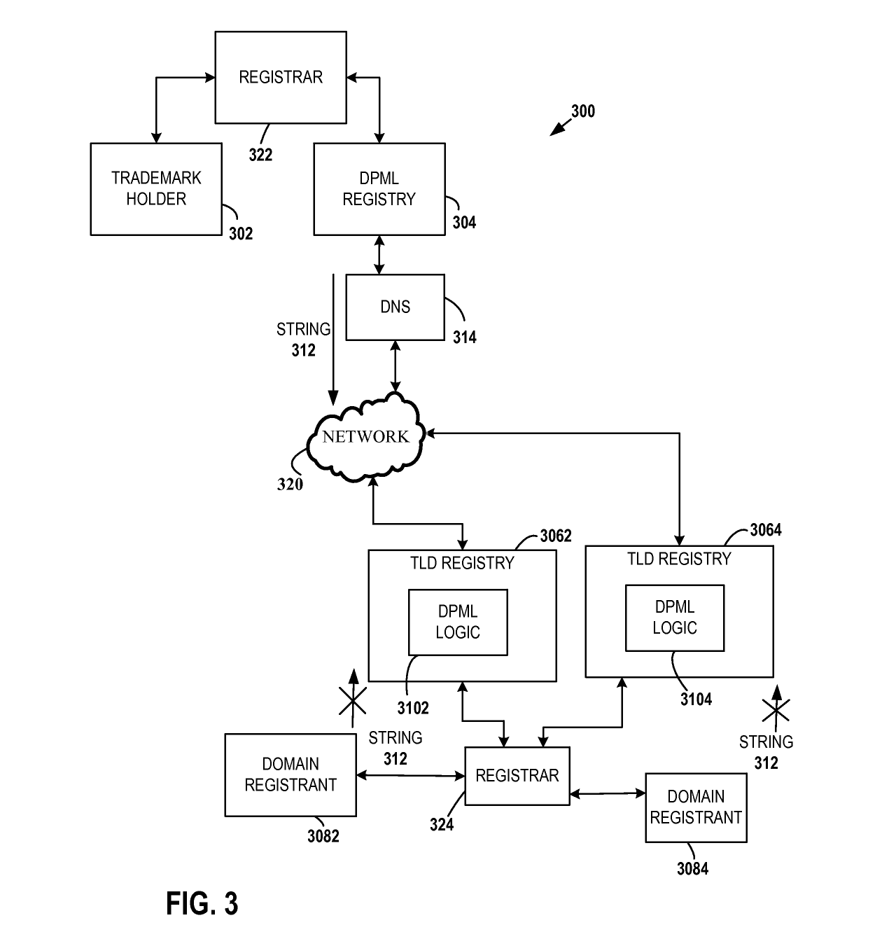

FIG. 3 illustrates a system 300 for protecting trademarks via the DPML registrations in accordance with embodiments described herein. The system 300 includes one or more computing devices associated with the various entities transferring data via the communication network 320. The computing devices include one or more processors that execute programming logic stored on processor-readable storage media for implementing the procedures described herein. The DPML service in accordance with embodiments detailed herein provides a decision point within the standard domain name registration process such that a domain name is queried against a distributed database in the DNS of all registries participating in the DPML blocking service. When a trademark holder 302 successfully registers a DPML registration string 312 with a DPML registry 304 through a registrar 322 via the DNS 314, the DPML registration string 312 is published by the DPML registry to the distributed DNS database. This prevents domain name registrations for the string 312 within the TLD registries 3062, 3064 participating in the DPML service. In an embodiment, each of the TLD registries 3062, 3064 participating in the DPML service respectively execute DPML logic 3102, 3104 that prevents registration of domain names for ‘string’ 312. Accordingly, when one or more domain name registrants 3082, 3084 other than the trademark holder 302 request registration for a domain name—‘string’ 312, for example, through a registrar 324, the DPML logic 3102, 3104 executed by respective registries 3062, 3064 causes the registration to fail as a domain name for the ‘string’ 312 is already registered by each TLD registry 3062 and 3064 via the DPML registration process.

It may be appreciated that only two TLDs 3062, 3064 are illustrated for brevity, however, the string 312 may be simultaneously blocked from registration across all TLDs operated by participating registries. Domain names which contain the string can be ‘Unblocked’ by the customer who originally blocked them. When the domain names are unblocked, all the blocked names become available for general registration. For example, Verizon has ‘yellowpages’ in the TMCH and may choose to block any domain name that contains an exact match of the selected trademark in accordance with embodiments described herein. So any of ‘yellowpages, ‘myyellowpages’, ‘yellowpagesonline’ may be blocked by Verizon. Implementation of DPML services in accordance with the various embodiments disclosed herein provides the participating entities with an additional competitive advantage because of the protection of intellectual property interests in view of the new gTLD (generic Top Level Domain) program are of importance from a domain name policy perspective. DPML service provides popular brand name owners an addition tool to protect their valued trademarks from appearing in multiple gTLD extensions.

In one embodiment, registrars communicate to the registrants the breadth of the domain names that will be blocked and any limitations that can exist. For example, DPML does not guarantee to block:

1. Registry identified “premium” domain names

2. Currently registered domain names

3. Exact-match trademarks

4. Names that are changed from standard to premium

In one embodiment, each Registry may have domain names that are either reserved, premium priced or part of a set in a particular TLD. These domain names can vary from TLD to TLD but regardless these names cannot be blocked in their respective TLDs but will become blocked in all other TLDs. For example, a registrar may reserve or place a premium price on all one, two and three letter domain names in certain TLDs. In one embodiment, a registrar may also place a premium price on ‘blog’ in some or all TLDs. Assuming the previous scenarios, that would mean that a trademark holder could not get a DPML registration for a ‘ing’ or ‘blog’ and the registrar would be free to offer these labels as domain names for sale.

In an embodiment, DPML registrations cannot block previously registered domain names. If a DPML registration occurs after a domain name is already registered it will block registrations of that label in any TLD where the domain name is not already registered. Existing registrations will continue to live out a normal lifecycle and may never be blocked. If the domain name is deleted and eventually dropped, the block would prevent re-registration.

In one embodiment, DPML registrations can never block an exact match trademark registration by the trademark holder, whether during sunrise or general availability. A trademark holder, defined as the bearer of the SMD file, may always register an exact match domain whether they are the registrant of a DPML or not. The presence of a valid SMD file should cause the SRS (Shared Registry System) to not check DPML when registering a domain name. The domain being registered must be listed as a valid label in the SMD file. In other words, during general availability or sunrise, a trademark holder can pass their SMD file at any time to override the DPML check as long as the domain they are registering is listed in the SMD file.

In one embodiment, each Registry, at their discretion, may also change a standard priced name to a premium name. This would have the effect of allowing that domain to be available for registration regardless of DPML.

In one embodiment, a DPML registration is priced to benefit the trademark holder by allowing flexibility in the future should the holder wish to lift the block and register a domain name using the blocked string. Like a domain registration, DPML pricing is on an annual basis. In a further embodiment, an optional delete fee can be available for configuration. A trademark holder with a trademark that is an exact match to a DPML block may still register the trademark but must pay an override fee.

At any time, either during ICANN sunrise period or general availability, any trademark holder may register an exact match trademark which has a DPML block on it, provided they have a valid SMD file from TMCH. This trademark holder does not necessarily need to be the registrant of the DPML block. They may only register a domain name where the domain name label is an exact match to their trademark as listed in the SMD file. If the registry receives a create command through EPP or the web interface for a domain name and it is accompanied by a valid SMD file using the community developed EPP extension, the domain registration may succeed and the applicable registration fee charged.

In an embodiment, if the domain name is a premium name, only the premium fee is charged since the domain name was never blocked in the first place. This also applies to the sunrise period. If the domain name is a premium name in sunrise, the premium price should be charged overriding the sunrise price. A registrar may promote a standard priced domain name to premium status. This would have the effect of unblocking the name. If a registrant chooses to remove their DPML, (domain names are immediately available), no override fee is paid for domain registrations after DPML is removed. To re-apply DPML, they would need to ‘restore’ it and pay the restore fee. The trademark holder runs the risk of others registering their protected string in the interim. In a further embodiment the override fee can be configurable to allow for a “base-price+adjustment=override fee”.

In an embodiment, a DPML lifecycle is similar to that of the domain name. In an embodiment, these parameters can be configured by a registrar. In one embodiment, a DPML registration has the same grace periods as a domain name. On creation, the DPML registration will enter the add-grace period for five days. The registration may be deleted at no cost within this period and the registration fee is refunded. Upon expiration, DPML registrations are auto-renewed for a period of one year. It will enter into the auto-renew grace period, which lasts for 45 days. During this time, the DPML registration can be deleted at no cost even if the delete fee is non-zero. If the DPML registration is transferred during the auto-renew period, the losing registrar will receive a credit for the auto-renew fees. Just like a domain name, renewing DPML can be done for one or more years providing the renewal does not allow the expiration date to exceed ten years. The price of a renewal or auto-renewal can be the same as the initial create price per year the expiration is extended. Once renewed, the DPML registration will enter a renew-grace period allowing a refund on the renew price if the DPML is deleted. Transferring a DPML registration will extend the expiration date by one year but it cannot exceed ten years similar to a domain name. By successfully transferring a DPML registration, it enters the transfer-grace period for five days. While in this period, the registration may be deleted and the delete price will be charged but the transfer fee will be refunded. When the DPML registration is deleted, with the exception noted above during auto-renew. The registration will go through the redemption grace period exactly as a domain name registration. The DPML zone record, if it exists, must be removed from DNS during the redemption grace period. This makes the string immediately available for registration. If the string is restored, the restore fee is charged and the DPML returns to an active status. The zone record, if it exists, will be returned to DNS. If the registration is not restored, it will enter the pending-delete period for five days after which it is deleted.

In one embodiment, the DPML system may record transactions in the finance exchange database for the gTLD registry system. It is treated just like a TLD. DPML shares the same registry database as gTLD so that both registrar accounts and registrar balances may be used for access control and funding for DPML registrations. In one embodiment, the DPML has support in the registrar administration web site as well as the product administration portal. Although EPP can be the predominant mechanism for registrars to provision and manage DPML, registrars can also perform the same operations through the registrar web site.

In an embodiment, DPML registrations can be made available via the standard DNS mechanism as discussed further herein. Registrars can be required to pass a fully qualified domain name (FQDN) in the EPP command to create the registration. In order for the blocked string to appear properly in DNS it must be a fully qualified domain name. In an embodiment, Registrars need to append a suffix (DPML suffix), such as, ‘.dpml’ to each string as part of the registration.

For example, if the blocked string is myverizon, registrars can pass myverizon.dpml as the FQDN in the EPP create command. This is the domain name that is published to DNS. If the registrar does not supply a correct suffix, the command may result in an error.

The following are the Domain Mapping EPP Considerations for DPML provisioning.

For example, in a domain:check command of one embodiment, the blocked string is to be appended with the DPML suffix; multiple strings may be checked in a single command; no price category data is required since there is only one price for a DPML registration; DPML can have access to the ICANN reserved name list and prevent registration of ICANN reserved names; there are no extension requirements for the check command; and validation of the DPML string and SMD file are performed by the domain:create command. In one embodiment, domain:check operations consider DPML data when determining domain name availability.

For example, in a domain:create command of one embodiment, the blocked string is to be appended with the DPML suffix; a valid Signed Mark Data (SMD) file is to be present in the command via the community developed EPP extension; the SMD file lists valid domain labels that may be used for registration; the blocked string (sans DPML suffix) is to contain one of the validated strings in the SMD with one exception: if the authInfo element of the create command contains a valid DPML string, validation policies are bypassed; the command may require the same contact information for DPML as in a typical domain registration; and name server delegation is not permitted. Including name server information with the domain:create command can result in an error. Name server host names cannot be created based on DPML registrations. Attempts to create name server hosts using a DPML name can result in an error. In one embodiment, domain:create operations consider DPML data before provisioning a domain name since it is not guaranteed that a check was performed.

For example, in a domain:info command of an embodiment, the blocked string is to be appended with DPML suffix. Same data may be required for DPML as a typical domain registration. The display of the SMD file data may be limited to the sponsoring registrar. If an SMD file was used for registration, basic SMD file information should be included such as serial number, Trademark holder and other pertinent information.

For example, in a domain:update command of an embodiment, contacts may be the only updatable fields; and SMD file data may not be updated.

For example, in a domain:delete command of an embodiment, appropriate fee is to be charged with the exception of the add-grace and auto-renew periods; and DPML registration enters RGP and may be restored except for add-grace period.

For example, in a domain:transfer command of an embodiment, DPML registrations can be transferred using the same standards and policies as a regular domain name. Like a domain name, registration periods may not exceed 10 years.

For example, in a domain:renew command of an embodiment, DPML registrations can be renewed using the same standards and policies as a regular domain name. Like a domain name, registration periods may not exceed 10 years.

Redemption Grace Period Mapping: in one embodiment, DPML registrations follow the same standards as domain names regarding RGP mapping as well as registry policies for grace periods and restoration procedures. Restore report and restore fee is charged as normal.

Host Mapping: in an embodiment, name server host names cannot be created based on DPML registrations. Attempts to create name server hosts result in an error.

Contact Mapping: in one embodiment, Contacts are associated with DPML registrations using the same standards as a regular domain name.

TLD SRS Server: in one embodiment, Shared Registry System (SRS) servers providing EPP services need access to a highly available store containing DPML registration availability. DPML registrations are published to DNS making them highly durable and available for SRS servers to check for DPML registrations.

In one embodiment, DPML registrations follow the same standards as domain names regarding RGP mapping as well as registry policies for grace periods and restoration procedures. Restore report and restore fee is charged as normal.

DNS: in one embodiment, to increase the availability and durability of DPML data the DPML registrations are formatted as a FQDN and resource records are published to the DNS. This makes the data widely available to other participating TLDs by allowing them to simply set up DNS slaves. It also makes the data highly durable and easy to replicate in case of temporary down time. In an embodiment, there is no impact to DNS for TLDs.

WHO IS: in an embodiment, the registry will provide a WHOIS service to allow public access to blocked string information. When the registry WHOIS is queried for a domain name that is blocked, the WHOIS response can include descriptive text. In an embodiment, this text can state “This domain name is not registered. It is blocked from registration as a domain name by a DPML trademark registration”

In one embodiment, the WHOIS query result will indicate what the actual Trademark is in WHOIS. The WHOIS query result will not claim ownership of the string but can state: “This string is, or contains, a trademark.” (NOTE: The output is dependent on whether it is a ‘contains’ DPML or exact match) “If you have an exact match trademark for this string, it may available for registration.” It may be appreciated that text for various messages is disclosed only by the way of illustration and not limitation and can change or have additions but this is the spirit of the WHOIS output. The whois output pulls from the DNS entry for the DPML registration.

Escrow: in an embodiment, escrowing of DPML data is not required as it is with domain name registration data. DPML does not affect or change a TLD's normal escrow requirements for ICANN.

Registry Startup Phases: in an embodiment, DPML is in effect at all times, including the ICANN mandated sunrise period. It works the same at sunrise as any other time. DPML does not prevent exact match domain registrations during the sunrise (or any) period. DPML does not change the behavior of the ICANN mandated sunrise phase of the registry. DPML affects the normal, general availability period and all other periods including any landrush and Trademark Claims periods of standard priced names.

Domain Lifecycle: in an embodiment, existing domain registrations are not impacted by a matching DPML registration. If a domain name was registered prior to a matching DPML registration, it will continue to live out its registration lifecycle. DPML will only block any new registrations in other TLDs where that domain name does not exist. If an existing domain name is subsequently deleted, it will be blocked from being re-registered for as long as the DPML registration is valid.

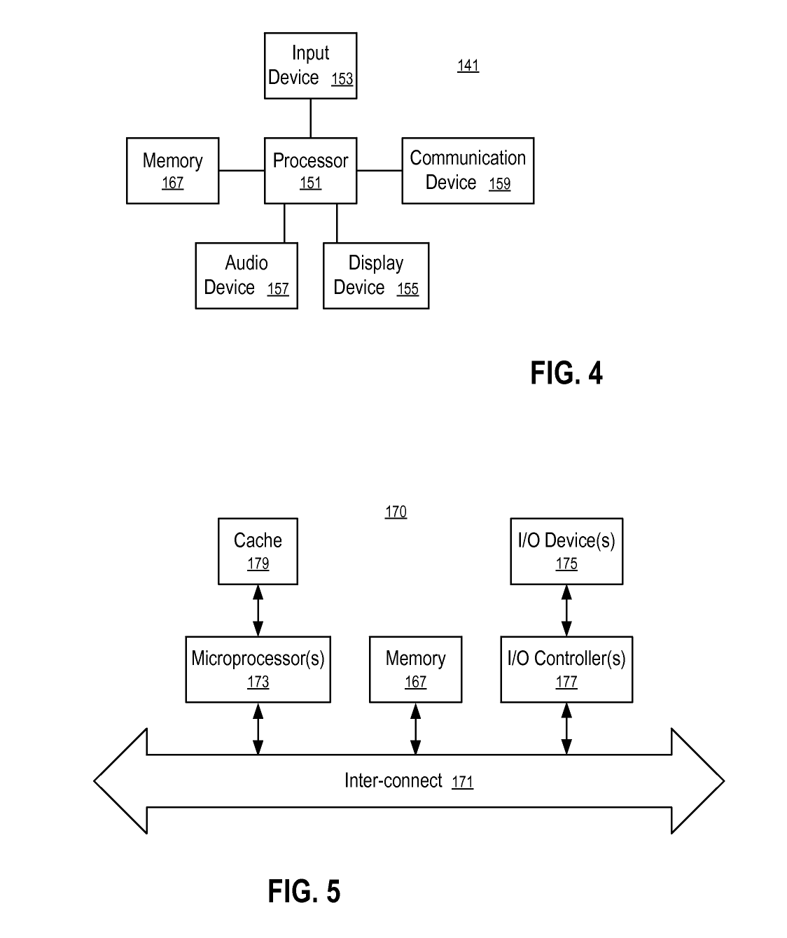

FIG. 4 illustrates an example of computing devices that can be employed to execute the various method described herein. The computing device 141 can include an input device 153 for receiving input regarding various DPML transactions. The input data can be transmitted to the processor 151 which analyzes the data and executes requisite actions based on, for example, instructions stored in the memory 167. An audio device 157, display device 155 are provided as example output devices to convey different messages as outlined herein to the users administering the DPML blocking system. A communication device 159 is provided to facilitate communication of the computing device 141 with other devices it may be networked with.

FIG. 5 is an example of a data processing device for implementing the DPML blocking system in accordance with one embodiment. The data processing device 170 includes one or more microprocessors 173 that carry a cache memory for storing instructions, a disparate memory which can include computer readable storage media such as but not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other non-transitory physical or material medium which can be used to tangibly store the desired information or data or instructions and which can be accessed by the microprocessors 173. I/O devices 175 described herein are controlled by I/O controllers 177 which can be software/hardware or combinations thereof. An inter-connect 171 such as a computer bus known in the art is used to connect the various devices.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1-9. (canceled)

10. A non-transitory computer storage medium storing instructions configured to instruct a computing apparatus to at least:
receive, by the computing apparatus from a prospective domain name registrant, a request for registering a string as a domain name in a top level domain;
determine, by the computing apparatus, if the string is a registered domain name in the top level domain;
determine, by the computing apparatus, if a DPML (Domain protected marks list) registration exists for the string;
block, by the computing apparatus, registration of the string as a domain name in the top level domain if the string is a currently registered domain name in the top level domain or if the DPML registration exists for the string; and
override, by the computing apparatus, registration block of the string based on the DPML registration and registering the string as a domain name in the top level domain if the prospective domain name registrant also provides digital proof of ownership, signed by a trusted authority, of the trademark associated with the request.

11. The medium of claim 10, wherein the instructions are further configured to instruct the computing apparatus to:
determine, by the computing apparatus, if the digital proof of ownership comprises the string if it is determined that the string is not registered as a domain name in the top level domain;
register, by the computing apparatus, the string as a top-level domain if the digital proof of ownership comprises the string; and
reject, by the computing apparatus, the request for registration if the digital proof of ownership does not comprise the string.

12. The medium of claim 10, wherein the instructions are further configured to instruct the computing apparatus to:
reject, by the computing apparatus, the request for registration when the digital proof of ownership is not received from the prospective domain name registrant.

13. A computing apparatus, comprising:
at least one microprocessor, and
a memory storing instructions configured to instruct the at least one microprocessor to at least:
receive a request to register a string in a domain name system, wherein the string includes a registered trademark and the request includes a digital proof of ownership of the string including the registered trademark;
responsive to a determination that the string has not already been registered in the domain name system, store data to register the string in the domain name system, wherein the data does not register the string as a domain name; and
reject requests to register the string as a domain name under one or more top-level domains, based on the data stored to register the string, in response to determination that the requests do not include the digital proof.

14. The computing apparatus of claim 13, wherein based on the data stored to register the string, the computing apparatus rejects requests, that do not include the digital proof, for registering the string as a domain number under any of a plurality of top-level domains.

15. The computing apparatus of claim 14, wherein the instructions are further configured to instruct the computing apparatus to:
allow, when the data is stored to register the string, a second request to register the string as a domain under one of the plurality of top-level domains, if the second request includes the digital proof.

16. The computing apparatus of claim 13, wherein the digital proof includes identifies the string as a protectable variation of the registered trademark.

17. The computing apparatus of claim 13, wherein the request is received via a protocol to register the string as a domain name under a top-level domain, and the request is configured to specify the string as a pseudo domain name under a pseudo top-level domain pre-associated with a list of registered strings for blocking domain name registration of the strings requested without digital proofs of trademark ownership.

18. The computing apparatus of claim 13, wherein in absence of the data stored to register the string, requests to register the string as a domain name under one or more top-level domains would be allowed if the domain name under the one or more top-level domains are not already been registered.

19. The computing apparatus of claim 13, wherein the digital proof includes a signed mark data file issued by a trademark clearing house.

20. The computing apparatus of claim 19, wherein the signed mark data file lists a plurality of strings, including the string identified in the request, as a variation of the registered trademark.

21. A method implemented in a computing system for domain name registration, the method comprising:
receiving, in the computing system, a request to register a string in a domain name system, wherein the string includes a registered trademark and the request includes a digital proof of ownership of the string including the registered trademark;
responsive to a determination that the string has not already been registered in the domain name system, storing in the computing system data to register the string in the domain name system, wherein the data does not register the string as a domain name;
receiving, in the computing system, requests to register the string as a domain name under one or more top-level domains;
determining, by the computing system, whether the requests include with the digital proof;
rejecting, by the computing system, a portion of the requests that does not include the digital proof, based on the data stored to register the string; and
accepting, by the computing system, at least one of the requests that includes the digital proof, in view of the data stored to register the string.

22. The method of claim 21, wherein based on the data stored to register the string, the computing apparatus rejects requests, that do not include the digital proof, for registering the string as a domain number under any of a plurality of top-level domains.

23. The method of claim 21, wherein the digital proof includes identifies the string as a protectable variation of the registered trademark.

24. The method of claim 21, wherein the request to register the string is received via a protocol to register the string as a domain name under a top-level domain.

25. The method of claim 21, wherein the protocol includes one of: extensible provisioning protocol (EPP), and registry registrar protocol (RRP).

26. The method of claim 24, wherein the request to register the string specifies the string as a pseudo domain name under a pseudo top-level domain pre-associated with a list of registered strings for blocking domain name registration of the strings requested without digital proofs of trademark ownership.

27. The method of claim 26, wherein the pseudo top-level domain is .dpml; and the method further comprises:
publishing the data stored to register the string in a distributed database in domain name system having a plurality of registries of a plurality of top-level domains.

28. The method of claim 21, wherein in absence of the data stored to register the string, requests to register the string as a domain name under one or more top-level domains would be allowed if the domain name under the one or more top-level domains are not already been registered.

29. The method of claim 21, wherein the digital proof includes a signed mark data file issued by a trademark clearing house.

30. The method of claim 29, wherein the signed mark data file lists a plurality of strings, including the string identified in the request, as a variation of the registered trademark.
